(19) United States
(12) Patent Application Publication
(10) Pub. No.: US 2025/0298200 A1
(43) Pub. Date: Sep. 25, 2025

(54) WAFER ALIGNMENT IN MULTIPLE DIES

(71) Applicant: MELLANOX TECHNOLOGIES, LTD., Yokneam (IL)

(72) Inventors: Guy GREENBOIM, Beit-Herut (IL); Barak FREEDMAN, Binyamina (IL); Yaakov Yonatan LAYOSH, Ganei Modi’in (IL); Victor BIGIO, Ramat Gan (IL)

(73) Assignee: MELLANOX TECHNOLOGIES, LTD., Yokneam (IL)

(21) Appl. No.: 18/888,767

(22) Filed: Sep. 18, 2024

Related U.S. Application Data
(60) Provisional application No. 63/569,544, filed on Mar. 25, 2024.

(51) Int. Cl. G02B 6/42

(52) U.S. Cl. CPC G02B 6/423; G02B 6/4239; G02B 6/4245

(57) ABSTRACT

Some embodiments of the present disclosure are directed to wafer alignment in multiple dies. For example, a receptacle wafer and a photonic wafer may be prepared containing a plurality of individual dies. Further, these two wafers may be aligned, wafer bonded, and cut into the individual dies. Additionally, or alternatively, these individual dies may be ready to be attached to a substrate and require no further alignment. The method of the present disclosure may be (i) cost effective since a single, passive receptacle wafer alignment results in multiple dies, (ii) repeatable (e.g., less variance in production) since it utilizes silicon lithography alignment features and scalable silicon WOW assembly, and (iii) improve optical performance since the thin receptacle wafer has a lower height resulting in a shorter optical path.

### CROSS-REFERENCE TO RELATED APPLICATION

The present application claims the benefit of U.S. Patent Application No. 63/569,544 for a “Wafer-Based Receptacle for Silicon-Photonics Connector” filed Mar. 25, 2024, which is hereby incorporated by reference in its entirety.

### TECHNOLOGICAL FIELD

The present disclosure is directed to a wafer alignment in multiple dies and a method of manufacturing the same.

### BACKGROUND

With demand for high-speed and high-volume data communication increasing, communications providers are increasingly adopting optics-based communication solutions. To meet these demands, methods of improving the manufacturing of optical elements are being developed.

### GENERAL DESCRIPTION

In one aspect, the present disclosure is directed to a method of optically aligning a photonic wafer, that may include bonding a carrier wafer to a receptacle wafer including one or more receptacles for one or more corresponding photonic ICs (e.g., transceivers, MCM assemblies, combinations of lasers, optical amplifiers, waveguides, modulators, demodulators, photodetectors, and/or the like for use in quantum computing, fiber-optic communication, photonic computing, biomedicine, data centers, and/or the like), where each of the one or more receptacles may be configured to receive a respective connector for its corresponding photonic IC. In some embodiments, the method may include etching the receptacle wafer to form an optical path for each of the one or more receptacles. Further, the method may include bonding the receptacle wafer to the photonic wafer comprising the one or more corresponding photonic ICs.

In some embodiments, the method may include aligning each optical path of each of the one or more receptacles with a corresponding optical window of the one or more corresponding photonic ICs. Further, the method may include, after bonding the receptacle wafer to the photonic wafer, debonding the carrier wafer from the receptacle wafer. Additionally, or alternatively, the method may include, after bonding the receptacle wafer to the photonic wafer, simultaneously dicing the receptacle wafer and the photonic wafer to form the one or more receptacles and the one or more corresponding photonic ICs.

In some embodiments, the method may include thinning the receptacle wafer before bonding the receptacle wafer to the photonic wafer. Further, etching the receptacle wafer to form the optical path for each of the one or more receptacles may include etching the receptacle wafer to form the optical path for each of the one or more receptacles while the receptacle wafer is bonded to the carrier wafer. Additionally, or alternatively, the method may include etching the receptacle wafer to form one or more mechanical alignment features for aligning one or more connectors.

In some embodiments, the one or more mechanical alignment features may extend into the receptacle wafer away from a surface for receiving the one or more connectors. Additionally, or alternatively, the one or more mechanical alignment features protrude away from the receptacle wafer away from a surface for receiving the one or more connectors. Further, the carrier wafer may include one or more cavities corresponding to and configured to receive the one or more mechanical alignment features.

In another aspect, the present disclosure is directed to an electronic module that may include a photonic IC and a receptacle configured to receive a connector for the photonic IC, where the receptacle is wafer-bonded to the photonic IC. In some embodiments, the photonic IC may include an optical window, the receptacle may include an optical path aligned with the optical window, and the optical path may be etched through the receptacle. Further, the optical path may include adhesive bleeding stoppers configured to prevent adhesive securing the connector to the receptacle from entering the optical path. Additionally, or alternatively, the receptacle may include one or more mechanical alignment features for aligning the connector with the photonic IC.

In some embodiments, the one or more mechanical alignment features may be formed via etching the receptacle. Further, the one or more mechanical alignment features may extend into the receptacle away from a surface for receiving the connector. Additionally, or alternatively, the one or more mechanical alignment features may protrude away from the receptacle away from a surface for receiving the connector.

In some embodiments, the electronic module may include the connector and a clip configured to secure the connector to the receptacle, where the receptacle and the connector may be configured to optically align the connector with the photonic IC when the clip secures the connector to the receptacle. Further, the electronic module may be deployed in a transceiver device. Additionally, or alternatively, the electronic module may be deployed in a switch MCM.

The features, functions, and advantages that have been discussed may be achieved independently in various embodiments of the present disclosure or may be combined with yet other embodiments, further details of which may be seen with reference to the following description and drawings.

### BRIEF DESCRIPTION OF THE DRAWINGS

Having thus described embodiments of the disclosure in general terms, reference will now be made to the accompanying drawings, wherein:

FIG. 1 is a schematic, partially exploded, perspective view of an electronic module;

FIG. 2A schematically depicts a side view of a connector and a receptacle;

FIG. 2B schematically depicts a method of manufacturing an electronic device using the receptacle of FIG. 2A;

FIG. 3 is an electronic module, in accordance with an embodiment of the present disclosure;

FIG. 4 schematically depicts a method for manufacturing a receptacle, in accordance with an embodiment of the present disclosure;

FIG. 5 schematically depicts a method for manufacturing receptacles, in accordance with an embodiment of the present disclosure;

FIG. 6 schematically depicts a method for manufacturing receptacles, in accordance with an embodiment of the present disclosure;

FIG. 7 is a flowchart illustrating a method of manufacturing receptacles for a photonic wafer, in accordance with an embodiment of the present disclosure;

FIG. 8 is a flowchart illustrating an example method for providing optical communications via photonics collimators, in accordance with an embodiment of the present disclosure;

FIG. 9 is a flowchart illustrating an example method for providing optical communications via photonics collimators, in accordance with an embodiment of the present disclosure;

FIG. 10 illustrates an example computing system that may be embedded in a communication system, in accordance with an embodiment of the present disclosure; and

FIG. 11 illustrates a co-packaged system, in accordance with an embodiment of the present disclosure.

### DETAILED DESCRIPTION OF EMBODIMENTS

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, etc.), and may be used interchangeably with “one or more.” Where only one item is intended, the phrase “only one” or similar language is used. Also, as used herein, the terms “has,” “have,” “having,” or the like are intended to be open-ended terms. Furthermore, when it is said herein that something is “based on” something else, it may be based on one or more other things as well. In other words, unless expressly indicated otherwise, as used herein “based on” means “based at least in part on” or “based at least partially on.” Also, as used herein, the term “or” is intended to be inclusive when used in a series and may be used interchangeably with “and/or,” unless explicitly stated otherwise (e.g., if used in combination with “either” or “only one of”). Like numbers refer to like elements throughout. No element, act, or instruction used herein should be construed as critical or essential unless explicitly described as such.

Multi-die devices are often provided with dies mounted in a face-to-back arrangement. In particular, single dies are often front to back so a stacked arrangement may naturally follow from this configuration by stacking similarly arranged dies. However, using a face-to-back arrangement may require all signals to be communicated between the dies using Through Silicon Vias (TSVs) that extend through the entire bottom die. The size of the TSVs results in a lower density of interconnects between the dies, thereby limiting performance and design flexibility. Further, the dies may be connected using microbumps that require an underfill that compromises the thermal performance of the composite structure.

The challenges in forming semiconductor devices from multiple dies has impacted the types of devices, configurations, and components found in multi-die devices. Multi-die devices are often provided with dies mounted in a face-to-back arrangement as this is a natural arrangement of the dies from a design and fabrication standpoint. A face-to-face arrangement may allow for significantly higher density of interconnects between the dies by forming interconnects from bump pad metal but it is a less natural arrangement and introduces significant challenges from a design and fabrication standpoint. For example, semiconductor devices have not used a face-to-face arrangement of semiconductor dies that each include a graphics processing unit (GPU) due to these challenges. In such configurations, many signals may be needed for the GPUs to communicate between chips, the GPU in a semiconductor die may require more power than can practically be delivered and die sizes may be large enough that yields are prohibitively low. Further, it may be desirable to form one or more inductors over the semiconductor substrate of one or both dies, such as for high-speed clock operation and/or power filtering, but interference from an adjacent die may degrade an inductor's performance. As such, these types of inductors have not been used in semiconductor devices with face-to-face die arrangements.

One or more electronic circuits may be formed, at least partially within a semiconductor substrate. An electronic circuit may include one or more transistors. For example, the electronic circuit may form at least a portion of a GPU and a semiconductor die may be a GPU die. However, various types and configurations of electronic circuits are contemplated as being within the score of the present disclosure. As some examples, the semiconductor substrate may include one or more circuit components of a processing unit, a Central Processing Unit (CPU), a single transistor (e.g., a power transistor), a logic circuit, a power circuit,, one or more core digital Application Specific Integrated Circuits (ASICs), microprocessors, FPGAs, and a transmitter and/or receiver, photonic high-speed optical interconnect components with functional switch application-specific integrated circuits (ASICs), a collection of logic gates or transistors, resistors, capacitors, inductors, diodes, a switch (e.g., a high-speed network switch), a network adapter, a memory device, an input/output (I/O) device, other peripheral devices or components on a system-on-chip (SoC), or other devices and components at which a signal is received or measured, Integrated Circuit (IC) chip, etc. combinations thereof, and the like. Where the semiconductor substrate includes a processing unit, the processing unit may include any number of cores. For example, where the processing unit is a GPU, the GPU may include multiple Streaming Multiprocessors (SMs) and each Streaming Multiprocessor may include a number of cores.

Silicon Photonics (SiP) is a technology that enables optical systems to be manufactured using silicon processes with silicon as the optical medium. Various optical components, such as interconnects and signal processing components, may be fabricated and integrated in a single SiP device. Some SiP devices are fabricated on a silica substrate or over a silica layer on a silicon substrate, a technology that is often referred to as Silicon on Insulator (SOI). In certain optical systems, a SiP device is attached to an external device to facilitate optical communications. However, it is generally difficult to accurately align light signals on the SiP with an external device that receives the light.

In certain optical systems, a SiP device is attached to an external device to facilitate optical communications. However, it is generally difficult to accurately align light signals on the SiP with an external device that receives the light. For instance, long range transmission of light signals is generally performed within optical fibers. When optical signals are generated or processed in a SiP device for transmission over optical fibers, the light needs to be coupled between the SiP device and the optical fibers. This coupling between the SiP device and the optical fibers is generally difficult because waveguides within the SiP device generally comprise a smaller diameter than the optical fibers. As such, a “world-to-chip” interface problem often arises in SiP technologies where coupling of light between Si wire waveguides and optical fibers, and vice versa, is generally inefficient.

Traditionally, for fiber-to-chip coupling, a fiber coupling technique using spot-size converters (SSCs) or grating couplers is employed. However, grating couplers for fiber-to-chip coupling typically provide a narrow bandwidth and/or an undesirable polarization sensitivity for certain optical applications. Furthermore, SSCs and grating couplers for fiber-to-chip coupling are generally attached to the chip through an adhesive bonding technique that results in a silicon communication chip with bundles of fibers attached thereto, resulting in increased complexity for handling and/or assembly of the chips onto other optical systems. Additionally, wafers for traditional SiP devices are generally diced (e.g., fully cut through) to create an edge for the wafer to expose waveguide facets and/or to facilitate butt attachment of the SiP device to an external device.

Current methods of manufacturing photonic devices involve optical elements that require active alignment in order to transmit the optical signal properly. For example, in the current method of manufacturing, a single receptacle is attached to a single photonic integrated circuit (IC). Such a process requires a complex active alignment step for each photonic IC, increasing production cost and time. Further, individually aligning each photonic IC entails a higher susceptibility to variance in the assemblies.

Embodiments of the present disclosure use advanced wafer-on-wafer (WoW) bonding techniques. In some embodiments, a receptacle wafer (e.g., a piece of semiconductor material including a plurality of individual receptacles) and a photonic IC wafer (e.g., a piece of semiconductor material including a plurality of individual photonic ICs) may be prepared containing a plurality of individual dies. Further, these two wafers may be aligned, wafer bonded, and cut into the individual dies. Additionally, or alternatively, these individual dies may be ready to be attached to a substrate and require no further alignment. The method of the present disclosure may (i) be cost effective since a single, passive receptacle wafer alignment results in multiple dies, (ii) be repeatable (e.g., less variance in production) since it utilizes lithography alignment features and scalable WoW assembly, (iii) improve optical performance since the thin receptacle wafer has a lower height resulting in a shorter optical path, and (iv) reduce power consumption.

In some embodiments, a method of manufacturing a receptacle for a connector may provide a receptacle wafer, where the receptacle wafer contains a plurality of individual receptacles. Further, a photonic IC wafer may be provided, where the photonic IC wafer contains a plurality of individual photonic IC dies. In some embodiments, the receptacle wafer may be disposed on top of the photonic IC wafer. Additionally, or alternatively, the receptacle wafer may be aligned with the photonic IC wafer (e.g., using wafer alignment features) such that each individual receptacle of the receptacle wafer and each individual photonic IC of the photonic IC wafer are optically aligned. In some embodiments, once the two wafers are optically aligned, the two wafers may be wafer bonded to one another. Further, once the two wafers are bonded, the wafers may be cut into individual dies that include an individual receptacle that may be optically aligned to an individual photonic IC.

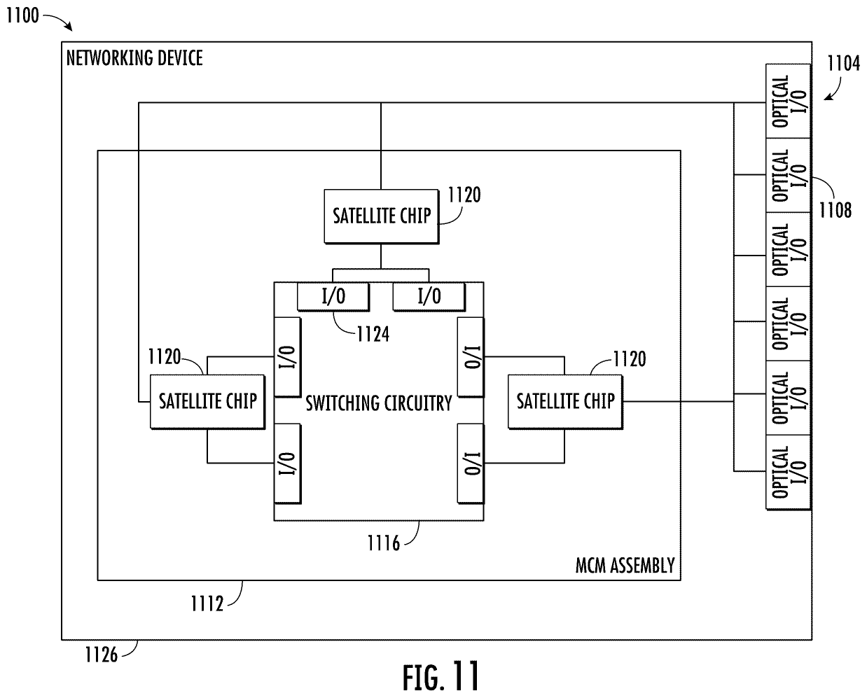

Embodiments of the present disclosure provide for individual dies that may be ready to be attached to a substrate and may require no further alignment. Further, embodiments of the present disclosure may be used, in particular, for pluggable transceivers and switch multichip modules (MCMs) (e.g., by providing an individual die including an optically aligned receptacle and photonic IC to serve as an optical component of the pluggable transceiver and/or switch MCM) as described further below with respect to FIG. 11. The method of manufacturing of the present disclosure may accurately and reliably produce a plurality of optically aligned receptacle and photonic IC stacks (e.g., a photonic IC disposed on and/or under, and optically aligned to, a receptacle) photonic IC disposed near, on, and/or under a plurality of optical, mechanical, and/or electrical components). As will be appreciated by one of ordinary skill in the art in view of the present disclosure, using WoW bonding techniques, the manufacturing method of the present disclosure may be cost effective since a single, passive receptacle wafer alignment results in multiple dies, repeatable (e.g., less variance in production) as it utilizes lithography alignment features and scalable WoW assembly, and improve optical performance as the thin receptacle wafer has a lower height resulting in a shorter optical path.

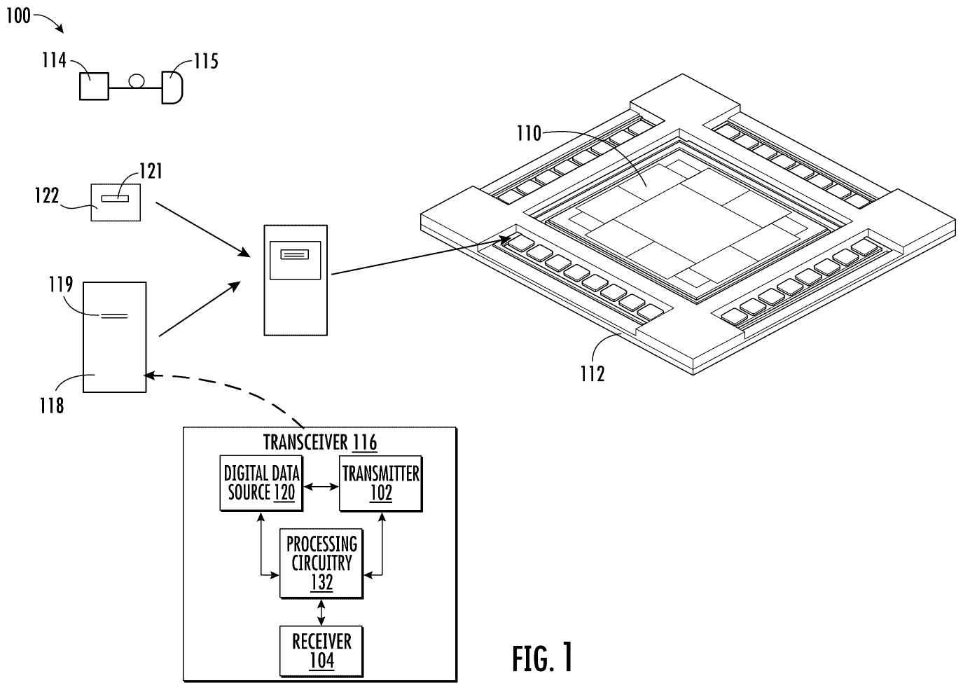

FIG. 1 is a schematic, partially exploded, perspective view of an electronic module 100 (e.g., an electronic device, a CPO package, a chip-on-wafer device, a silicon photonic IC, a photonic wafer, and/or the like). As shown in FIG. 1, the electronic module 100 may include a substrate 112, a chip-on-wafer 110 (e.g., a main die), and at least one photonic IC 118 (e.g., a chip containing a plurality of photonic components that may form a functioning circuit and/or that may generate, transmit, detect, and/or process light). As also shown in FIG. 1, the chip-on-wafer 110 may be positioned on a central portion of the substrate 112, and the photonic IC 118 may be positioned on a peripheral portion of the substrate 112. As will be appreciated by those of ordinary skill in the art in view of this disclosure, a representative photonic IC 118 is depicted on the left side of FIG. 1 as being representative of the photonic IC 118 on the peripheral portion of the substrate 112.

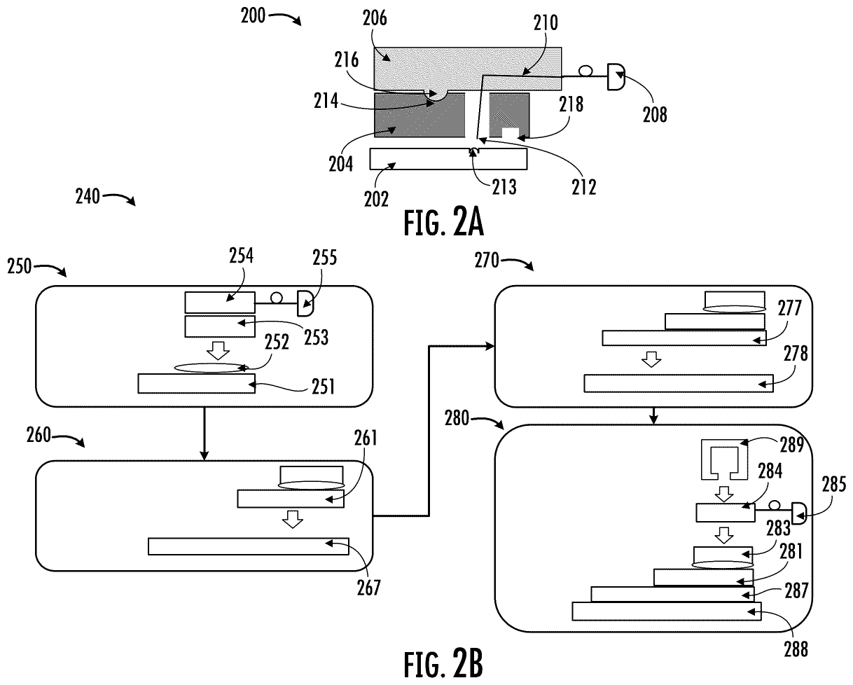

As shown in FIG. 1, a receptacle 122 (e.g., similar to a receptacle 204 shown and described herein with respect to FIG. 2) including an optical window 121 may be positioned on each of the photonic ICs 118, and each receptacle 122 may be configured to align its optical window 121 and a corresponding detachable connector 114 with an optical window 119 of a corresponding photonic IC 118. In some embodiments, the corresponding photonic IC 118 may be a photonics transceiver module for sending and receiving signals, for example, data signals. The transceiver 116 may be connected to a node, such as a server. The data signals may be digital or optical signals modulated with data or other suitable signals for carrying data. The transceiver 116 may include a digital data source 120, a transmitter 102, a receiver 104, and processing circuitry 132 that controls the transceiver 116. The digital data source 120 may include suitable hardware and/or software for outputting data in a digital format (e.g., in binary code and/or thermometer code). The digital data output by the digital data source 120 may be retrieved from memory (not illustrated) or generated according to input (e.g., user input). The transceiver 116 or selected elements of the transceiver 116 may take the form of a pluggable card or controller for the device 110. For example, the transceiver 116 or selected elements of the transceiver 116 may be implemented on a network interface card (NIC).

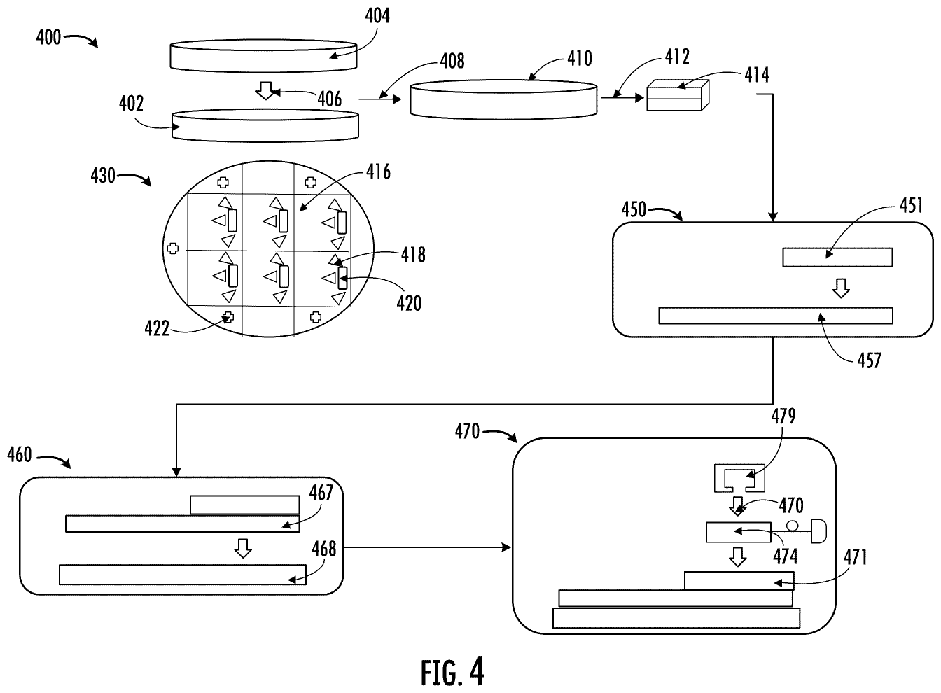

In some embodiments, the receptacle 122 may be bonded and actively aligned to the photonic IC 118 to form a SiP with receptacle stack during a method of manufacturing shown and described herein with respect to FIG. 4. The detachable connectors 114 may be connected via optical fibers to an optical connector 115 (e.g., an MPO connector and/or the like), which are in optical communication with one or more optical devices (not pictured). In this way, the receptacles 122 and the detachable connectors 114 optically connect the photonic ICs 118 of the electronic module 100 to one or more optical devices.

In some embodiments, one or more of the photonic ICs 118 may be configured to receive electrical signals from the chip-on-wafer 110 (e.g., via electrical traces through the substrate 112), convert the electrical signals to optical signals, and transmit the optical signals to one or more optical devices. Additionally, or alternatively, one or more of the photonic ICs 118 may be configured to receive optical signals from one or more optical devices, convert the optical signals to electrical signals, and transmit the electrical signals to the chip-on-wafer 110 (e.g., via electrical traces through the substrate 112).

FIG. 2A schematically depicts a side view of a connector and a receptacle 200. As shown in FIG. 2A, the receptacle 204 may include an optical window 212 that aligns with an optical path from a photonic IC 202 to the connector 206, and the connector 206 may provide an optical path 210 (e.g., using one or more waveguides, free space optics, metallic reflective mirrors, and/or the like) from the receptacle 204 to an optical fiber and a ferrule 208. As also shown in FIG. 2A, the connector 206 may include a connector alignment feature 216 and the receptacle 204 may include a receptacle alignment feature 214 corresponding to the connector alignment feature 216 such that, when the connector 206 is positioned on the receptacle 204, the optical window 212 of the receptacle 204 properly aligns the optical path 210 with the connector 206. In some embodiments, the receptacle 204 may include adhesive bleeding stop features 218, which may prevent an adhesive used to secure the receptacle 204 to the photonic IC 202 from blocking and/or entering the optical window 212. Further, the photonic IC 202 may include an optical I/O 213. As also shown in FIG. 2A, the receptacle 204 may have a height of approximately 700 microns to provide sufficient mechanical strength that the receptacle 204 may be positioned and adhered to the photonic IC 202.

FIG. 2B schematically depicts a method 240 of manufacturing an electronic device using the receptacle 204 of FIG. 2A. As shown in FIG. 2B, the method 240 may include a step 250 of actively aligning a receptacle 253 with the photonic IC 251. In this regard, the method 240 may include applying an adhesive 252 to a surface of the photonic IC 251 and/or a surface of the receptacle 253 and connecting a golden connector 254 (e.g., a test connector) with an attached ferrule 255 to the receptacle 253. The method 240 may further include actively aligning the optical window with an optical window of the photonic IC 251 while transmitting optical signals through the golden connector 254 and the receptacle 253 and testing the optical signals. The method 240 may include actively changing the position of the receptacle 253 on the photonic IC 251 to determine an optimal alignment of the receptacle 253 with respect to the photonic IC 251 that ensures complete and/or near-complete transmission of the optical signals through the golden connector 254 and the receptacle 253. The method 240 may include, upon determining an optimal alignment, curing the adhesive 252 to permanently adhere the receptacle 253 to the photonic IC 251.

As shown in FIG. 2B, the method 240 may include performing a flip-chip and reflow process 260 on the photonic IC 261 to mechanically and electrically connect the photonic IC 261 to a package substrate 267. As also shown in FIG. 2B, the method 240 may include performing a ball-grid-array (BGA) reflow process 270 to mechanically and electrically connect the package substrate 277 to a product printed circuit board (PCB) 278 (e.g., a device PCB, a system PCB, a switch PCB, and/or the like).

As shown in FIG. 2B, the method 240 may include a step 280 of positioning a connector 284 with an attached ferrule 285 on the receptacle 283 and securing the connector 284 to the receptacle 283 via a clip 289. Due to the corresponding alignment features of the connector 284 and the receptacle 283, the connector 284 aligns itself with the receptacle 283 such that the optical window of the receptacle 283 properly aligns the optical path with the connector 284.

By using a connector 284 that is detachable from the receptacle 283, the active alignment of the receptacle 283 with respect to the optical window of the photonic IC 281 may be performed and tested before the photonic IC 281 is mechanically connected to the package substrate 287 and/or the product PCB 288, that is, at the die level of assembly, rather than the device level of assembly. Being able to test the alignment at the die level allows for misalignments to be detected early in the assembly process such that, if misaligned, only the photonic IC 281 and the receptacle 283 are disposed of, rather than the entire device (e.g., including the package substrate, the product PCB, and/or the like).

However, the height of approximately 700 microns necessary to provide sufficient mechanical strength to the receptacle 283 increases the overall connector height, which must be accounted for in the overall device design. Furthermore, such a height increases the length of the optical path from the photonic IC to the connector, which increases the difficulty of aligning the photonic IC, receptacle, and connector and increases a likelihood of optical power loss.

Furthermore, actively aligning the receptacle 283 with the photonic IC 281 increases the cost of the die level assembly. In other words, by requiring an active alignment of the receptacle 283 with the photonic IC 281, the assembly of each individual die (e.g., each individual photonic IC and corresponding receptacle) must be uniquely controlled to obtain proper alignment, which increases assembly cost.

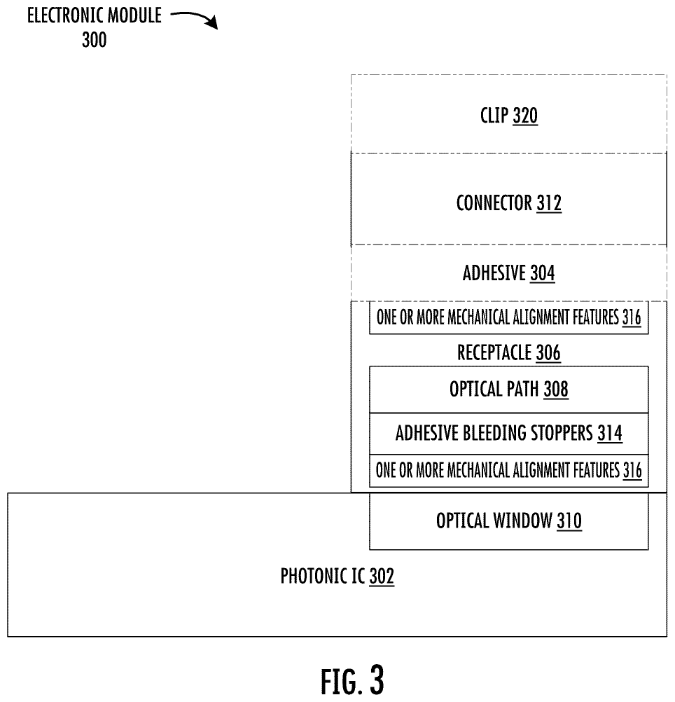

FIG. 3 is an electronic module, in accordance with an embodiment of the present disclosure. The electronic module 300 may include a photonic IC 302 and a receptacle 306 configured to receive a connector 312 for the photonic IC 302, where the receptacle 306 is wafer-bonded to the photonic IC 302. In some embodiments, the photonic IC 302 may include an optical window 310, wherein the receptacle 306 may include an optical path 308 aligned with the optical window 310, and the optical path 308 may be etched through the receptacle 306. Further, the optical path 308 may include adhesive bleeding stoppers 314 configured to prevent adhesive securing the connector 312 to the receptacle 306 from entering the optical path 308.

In some embodiments, the receptacle 306 may include one or more mechanical alignment features 316 for aligning the connector 306 with the photonic IC 302. Further, the one or more mechanical alignment features 316 may be formed via etching the receptacle 306. Additionally, or alternatively, the one or more mechanical alignment features 316 may extend into the receptacle 306 away from a surface for receiving the connector 312.

In some embodiments, the one or more mechanical alignment features 316 may protrude away from the receptacle 306 away from a surface for receiving the connector 312. Additionally, or alternatively, the electronic module 300 may include the connector 312 and a clip 320 configured to secure the connector 312 to the receptacle 306, where the receptacle 306 and the connector 312 may be configured to optically align the connector 312 with the photonic IC 302 when the clip 320 secures the connector 312 to the receptacle 306. In some embodiments, an adhesive 304 may secure the connector 312 to the receptacle 306.

Some embodiments of the present disclosure are directed to a receptacle, a photonic IC, a receptacle wafer, a photonic wafer, an electronic module, a method for manufacturing a receptacle, and/or the like in which a receptacle is wafer bonded to a photonic IC. For example, FIG. 4 schematically depicts a method 400 for manufacturing a receptacle, in accordance with some embodiments of the present disclosure.

As shown in FIG. 4, the method 400 may include bonding a receptacle wafer 404 to a photonic wafer 402 using a wafer-on-wafer bonding process 406 (e.g., a process that temporarily or permanently joins two or more wafers including or not including an intermediate layer (e.g., an adhesive)). In some embodiments, the receptacle wafer 404 may include a silicon wafer, a glass wafer, and/or the like. As also shown in a top view 430 of the receptacle wafer 404 of FIG. 4, the receptacle wafer 404 may include multiple receptacle dies 416, where each die 416 includes one or more mechanical alignment features 418 for a detachable connector and one or more optical path windows 420, including one or more adhesive bleeding stoppers.

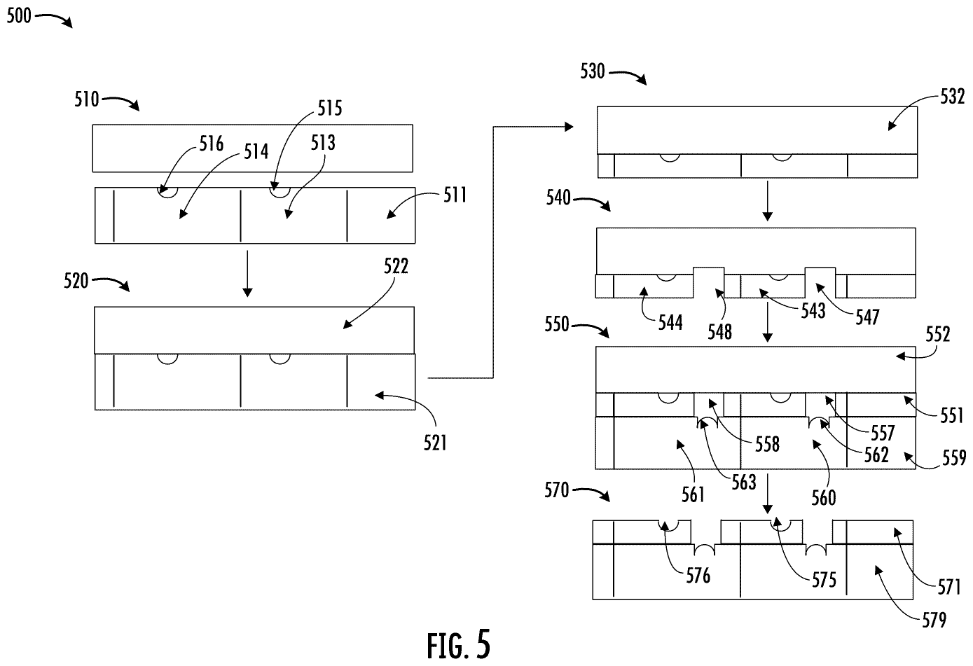

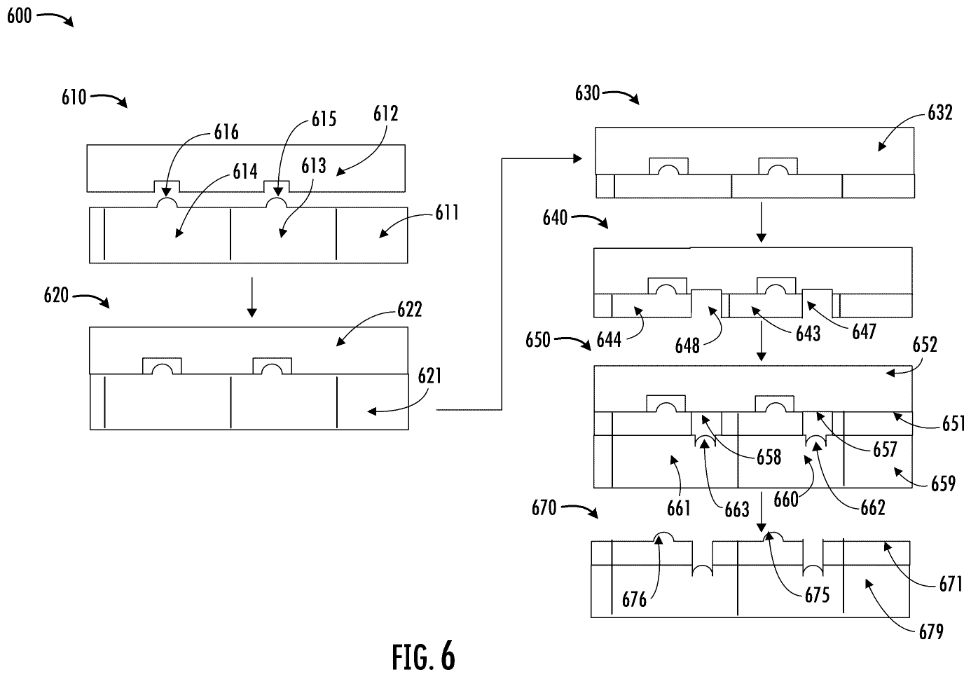

In some embodiments, the one or more mechanical alignment features 418 for a detachable connector may include triangular-shaped elements, globe-shaped elements, pyramid-shaped elements, and/or the like. Additionally, or alternatively, and as described further herein with respect to FIGS. 5 and 6, the one or more mechanical alignment features 418 for a detachable connector may (i) extend into the receptacle wafer 404 away from a surface for receiving the detachable connector and/or (ii) protrude away from the receptacle wafer 404 away from a surface for receiving the detachable connector. For example, some of the mechanical alignment features 418 may extend into the receptacle wafer 404 and other of the mechanical alignment features 418 may protrude away from the receptacle wafer 404.

In some embodiments, the one or more mechanical alignment features 418 for the detachable connectors may be configured to interact with one or more corresponding mechanical alignment features on the detachable connectors to achieve alignment of the optical path windows with respect to the detachable connectors. In other words, one or more mechanical alignment features 418 on a given receptacle die 416 may be configured to interact with one or more corresponding mechanical alignment features on a detachable connector such that the optical path window of the given receptacle die 416 is aligned with the detachable connector to establish an optical path for optical signals through the optical path window and the connector.

In some embodiments, and as shown in FIG. 4, each receptacle die 416 may include one or more adhesive bleeding stoppers. The adhesive bleeding stoppers may be configured to prevent any adhesive on the lower surface of the receptacle die 416 from entering the optical path window. For example, a receptacle wafer 404 may be adhered to a photonic wafer 402 using adhesive in a wafer-on-wafer bonding process 406, and the adhesive bleeding stoppers may prevent the adhesive from entering the optical path window.

As also shown in the top view 430 of the receptacle wafer 404 of FIG. 4, the receptacle wafer 404 may include wafer alignment features 422 configured to facilitate alignment of the receptacle wafer 404 with a photonic wafer 402. For example, although shown on a top surface of the receptacle wafer 404 in FIG. 4, the wafer alignment features 422 may be on a bottom surface of the receptacle wafer 404 and may align with corresponding wafer alignment features on the photonic wafer 402.

In some embodiments, optimal optical paths from the inputs/outputs of the photonic ICs (e.g., lenses on the photonic ICs) through the optical path windows of the receptacle wafer 404 and into the detachable connectors may be achieved via a series of micron-level and/or sub-micron-level alignment steps. For example, the alignment of the receptacle wafer 404 and the photonic wafer 402 may be controlled during the wafer-on-wafer bonding process 406 to a micron-level and/or sub-micron-level degree of accuracy using the wafer alignment features 422 on the receptacle wafer 404. Similarly, the mechanical alignment features 418 on each receptacle die 416 of the receptacle wafer 404 may formed to a micron-level and/or sub-micron-level degree of accuracy. In this way, precise alignment may be achieved to form optimal optical paths.

Because the receptacle wafer 404 and the photonic wafer 402 are aligned at the wafer level (e.g., using such topographic alignment features), the optical path windows of the receptacle wafer 404 may be accurately and passively aligned with the optical windows of the photonic wafer 402 (e.g., without the need for active testing as in an active alignment process). In some embodiments, the alignment features may be formed using silicon lithography to achieve manufacturing accuracy and repeatability. Additionally, or alternatively, one or more elements (e.g., the wafer alignment features, the mechanical alignment features, the optical path windows, and/or the like) of the receptacle wafer 404 may be formed using deep reactive ion etching (DRIE). Furthermore, such a scalable wafer-on-wafer assembly process is accurate and repeatable, which reduces manufacturing time and cost and increases yield.

In some embodiments, and as noted in FIG. 4, the method 400 may include thinning 408 the receptacle wafer 404 before or after bonding the receptacle wafer 404 to the photonic wafer 402. In some embodiments, the receptacle wafer 404 may be thinned to a height of between about 200 microns and 100 microns. Such low receptacle wafer heights may be used because the receptacle wafer 404 itself does not require mechanical strength due to the use of a wafer-on-wafer-bonding process 406 to bond the receptacle wafer 404 to the photonic wafer 402. In other words, the wafer-on-wafer-bonding process 406 may eliminate the need for the receptacle wafer 404 to have independent mechanical strength. In this way, such receptacles may reduce overall connector height, which increases flexibility in the overall device design. Furthermore, such a height reduces the length of the optical path from the photonic IC to the connector, which reduces the difficulty of aligning the photonic IC, receptacle, and connector and reduces a likelihood of optical power loss.

As also shown in FIG. 4, the method 400 may include dicing 412 the bonded receptacle wafer and photonic wafer 410 into singulated dies 314 including an individual photonic IC with a corresponding receptacle. For example, after bonding the receptacle wafer 404 to the photonic wafer 402, the method 400 may include dicing 412 the bonded receptacle wafer and photonic wafer 410 into the dies 416 shown in the top view 430 of the receptacle wafer 404 of FIG. 4.

As shown in FIG. 4, the method 400 may include performing a flip-chip and reflow process 450 on a photonic with receptacle chip 451 to mechanically and electrically connect the photonic with receptacle chip 451 to a package substrate 457. For example, the package substrate 457 may be similar to the substrate of the electronic module 100 as shown and described herein with respect to FIG. 1.

As shown in FIG. 4, the method 400 may include performing a BGA reflow process 460 to mechanically and electrically connect the package substrate 467 to a product PCB 468 (e.g., a device PCB, a system PCB, a switch PCB, and/or the like). For example, the product PCB 468 may be a PCB of a network switch.

As shown in FIG. 4, the method 400 may include positioning 470 a connector 474 on the photonic with receptacle chip 471 and securing the connector 474 to the photonic with receptacle chip using a clip 479. Due to the corresponding mechanical alignment features of the connector 474 and the photonic with receptacle chip 471, the connector 474 aligns itself with the photonic with receptacle chip 471 such that the optical path window of the photonic with receptacle chip 471 properly aligns the optical path with the connector 474.

FIG. 5 schematically depicts a method 500 for manufacturing receptacles, in accordance with an embodiment of the present disclosure. In some embodiments, the method 500 and/or steps described herein with respect to the method 500 may be performed in conjunction with and/or as one or more steps of the method 400 described herein with respect to FIG. 4.

As shown in FIG. 5, the method 500 may include the use of a carrier wafer, a receptacle wafer, and a photonic wafer with a top-side optical input/output interface. In some embodiments, the carrier wafer may be and/or include a wafer of sufficient mechanical strength to prevent warpage and/or damage to the receptacle wafer. Additionally, or alternatively, the receptacle wafer may be similar to the receptacle wafer as shown and described herein with respect to FIG. 4.

In some embodiments, the photonic wafer may be similar to the photonic wafer as shown and described herein with respect to FIG. 4. For example, the photonic wafer may include a plurality of photonic ICs.

As shown in step 510 of FIG. 5, the method 500 may include forming one or more mechanical alignment features in the receptacle wafer 511. For example, and as shown in FIG. 5, the method 500 may include etching the receptacle wafer 511 to form a first mechanical alignment feature 516 in a first receptacle 514 and/or a second mechanical alignment feature 515 in a second receptacle 513, where the mechanical alignment features 516 and 515 extend into the receptacle wafer 511 away from a surface for receiving connectors. In some embodiments, the receptacle wafer includes a plurality of receptacles that may each be etched to form mechanical alignment features.

As shown in step 520 of FIG. 5, the method 500 may include performing a wafer-on-wafer bonding process to bond the carrier wafer 522 to the receptacle wafer 521. As shown in step 530 of FIG. 5, the method 500 may include thinning the receptacle wafer 532. For example, the receptacle wafer 532 may be thinned to a height of between about 200 microns and 100 microns.

As shown in step 540 of FIG. 5, the method 500 may include etching a first optical path window 548 in the first receptacle 544 and/or a second optical path window 547 in the second receptacle 543. As shown in step 550 of FIG. 5, the method 500 may include performing a wafer-on-wafer bonding process to bond the receptacle wafer 551 to the photonic wafer 559. In this regard, because a wafer-on-wafer bonding process is used to bond the receptacle wafer 551 to the photonic wafer 559, the first optical path window 558 and/or the second optical path window 557 may be accurately and/or precisely aligned with a first optical I/O 563 (e.g., optical inputs, optical outputs, and/or the like) of a first die 561 of the photonic wafer 559 and/or a second optical I/O 562 of a second die 560 of the photonic wafer 559, thereby eliminating the need for performing active alignment. In some embodiments, the photonic wafer 559 may include a plurality of dies each with an optical I/O that may be accurately and/or precisely aligned with a corresponding optical path window of a respective receptacle of the receptacle wafer 551.

As shown in step 570 of FIG. 5, the method 500 may include debonding the carrier wafer 552 from the receptacle wafer 571. In some embodiments, and as shown in FIG. 5, debonding the carrier wafer 552 from the receptacle wafer 571 exposes the mechanical alignment features (e.g., the first mechanical alignment feature 576 and/or the second mechanical alignment feature 575) formed in each die in the receptacle wafer 571. As will be appreciated by those of ordinary skill in the art in view of this disclosure, the method 500 may include dicing the bonded receptacle wafer 571 and photonic wafer 579 into singulated dies (e.g., similar to the singulated die 414 shown and described herein with respect to FIG. 4) including an individual photonic IC with a corresponding receptacle and/or performing one or more of the steps of the method 400 as shown and described herein with respect to FIG. 4. As will also be appreciated by those of ordinary skill in the art in view of this disclosure, the method 500 may not include the use of a carrier wafer and instead use direct wafer-to-wafer bonding.

FIG. 6 schematically depicts a method 600 for manufacturing receptacles, in accordance with an embodiment of the present disclosure. In some embodiments, the method 600 and/or steps described herein with respect to the method 600 may be performed in conjunction with and/or as one or more steps of the method 400 described herein with respect to FIG. 4. Additionally, or alternatively, the method 600 and/or steps described herein with respect to the method 600 may be performed in conjunction with and/or as one or more steps of the method 500 described herein with respect to FIG. 5.

As shown in FIG. 6, the method 600 may include the use of a carrier wafer, a receptacle wafer, and a photonic wafer with a top-side optical input/output interface. In some embodiments, the carrier wafer may be and/or include a wafer of sufficient mechanical strength to prevent warpage and/or damage to the receptacle wafer. Additionally, or alternatively, the receptacle wafer may be similar to the receptacle wafer as shown and described herein with respect to FIG. 4.

In some embodiments, the photonic wafer may be similar to the photonic wafer as shown and described herein with respect to FIG. 4. For example, the photonic wafer may include a plurality of photonic ICs.

As shown in step 610 of FIG. 6, the method 600 may include forming one or more mechanical alignment features in the receptacle wafer 611. For example, and as shown in FIG. 6, the method 600 may include etching the receptacle wafer 611 to form a first mechanical alignment feature 616 in a first receptacle 614 and/or a second mechanical alignment feature 615 in a second receptacle 613, where the mechanical alignment features protrude away from the receptacle wafer 611 for receiving connectors. As also shown in FIG. 6, the carrier wafer 612 may include one or more carrier wafer cavities positionally corresponding to the one or more mechanical alignment features in the receptacle wafer 611. In some embodiments, the receptacle wafer 611 includes a plurality of receptacles that may each be etched to form mechanical alignment features.

As shown in step 620 of FIG. 6, the method 600 may include performing a wafer-on-wafer bonding process to bond the carrier wafer 622 to the receptacle wafer 621. As shown in step 630 of FIG. 6, the method 600 may include thinning the receptacle wafer 632. For example, the receptacle wafer 632 may be thinned to a height of between about 200 microns and 100 microns.

As shown in step 640 of FIG. 6, the method 600 may include etching a first optical path window 648 in the first receptacle 644 and/or a second optical path window 647 in the second receptacle 643. As shown in step 650 of FIG. 6, the method 600 may include performing a wafer-on-wafer bonding process to bond the receptacle wafer 651 to the photonic wafer 659. In this regard, because a wafer-on-wafer bonding process is used to bond the receptacle wafer 651 to the photonic wafer 659, the first optical path window 658 and/or the second optical path window 657 may be accurately and/or precisely aligned with a first optical I/O 663 (e.g., optical inputs, optical outputs, and/or the like) of a first die 661 of the photonic wafer 659 and/or a second optical I/O 662 of a second die 660 of the photonic wafer 659, thereby eliminating the need for performing active alignment. In some embodiments, the photonic wafer 659 may include a plurality of dies each with an optical I/O that may be accurately and/or precisely aligned with a corresponding optical path window of a respective receptacle of the receptacle wafer 651.

As shown in step 670 of FIG. 6, the method 600 may include debonding the carrier wafer 652 from the receptacle wafer 671. In some embodiments, and as shown in FIG. 6, debonding the carrier wafer 652 from the receptacle wafer 671 exposes the mechanical alignment features (e.g., the first mechanical alignment feature 676 and/or the second mechanical alignment feature 675) formed in each die in the receptacle wafer 671. As will be appreciated by those of ordinary skill in the art in view of this disclosure, the method 600 may include dicing the bonded receptacle wafer 671 and photonic wafer 679 into singulated dies (e.g., similar to the singulated die 414 shown and described herein with respect to FIG. 4) including an individual photonic IC with a corresponding receptacle and/or performing one or more of the steps of the method 400 as shown and described herein with respect to FIG. 4. As will also be appreciated by those of ordinary skill in the art in view of this disclosure, the method 600 may not include the use of a carrier wafer and instead use direct wafer-to-wafer bonding.

Although methods have been described herein that include using a wafer-on-wafer bonding process to create a receptacle on a photonic IC, some embodiments of the present disclosure may include using one or more silicon lithography techniques to form a receptacle on a photonic IC. For example, rather than forming receptacles on a receptacle wafer and using a wafer-on-wafer bonding process to bond the receptacle wafer to a photonic wafer, a photonic wafer may be grown to a greater thickness, and receptacles may be formed for each photonic IC of the photonic wafer on the upper surface of the photonic wafer using one or more lithography techniques.

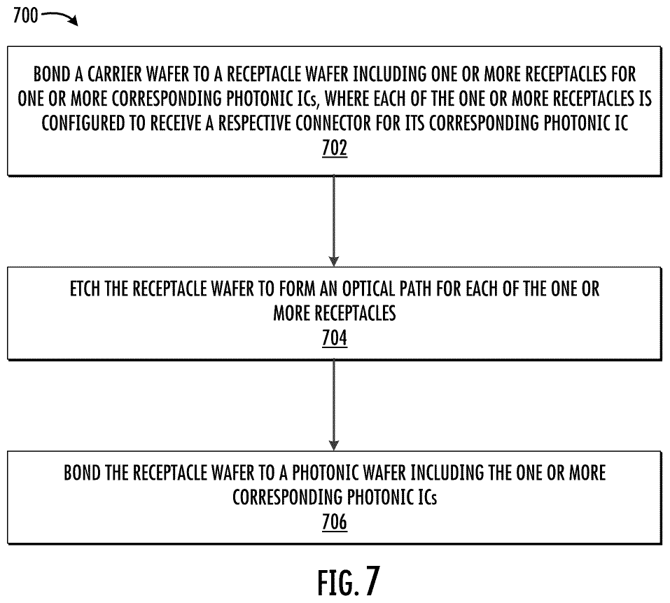

FIG. 7 is a flowchart illustrating a method 700 of manufacturing receptacles for a photonic wafer, in accordance with an embodiment of the disclosure. In some embodiments, the method 700 and/or steps described herein with respect to the method 700 may be performed in conjunction with and/or as one or more steps of the method 400 described herein with respect to FIG. 4. Additionally, or alternatively, the method 700 and/or steps described herein with respect to the method 700 may be performed in conjunction with and/or as one or more steps of the method 400 described herein with respect to FIG. 4. In some embodiments, the method 700 and/or steps described herein with respect to the method 700 may be performed in conjunction with and/or as one or more steps of the method 600 described herein with respect to FIG. 6.

As shown in block 702, the method 700 may include bonding a carrier wafer to a receptacle wafer including one or more receptacles for one or more corresponding photonic ICs, where each of the one or more receptacles is configured to receive a respective connector for its corresponding photonic IC. In some embodiments, the one or more receptacles may include a corresponding mechanical alignment feature. Further, the mechanical alignment features may extend into the receptacles (e.g., similar to the first mechanical alignment feature 516 and/or the second mechanical alignment feature 515 as shown and described herein with respect to FIG. 5) and/or protrude away from the receptacles (e.g., similar to the first mechanical alignment feature 616 and/or the second mechanical alignment feature 615 as shown and described herein with respect to FIG. 6). In some embodiments, the carrier wafer may be similar to the carrier wafers as shown and described herein with respect to FIGS. 5 and 6. Additionally, or alternatively, the receptacle wafer may be similar to the receptacle wafers as shown and described herein with respect to FIGS. 4-6.

As shown in block 704, the method 700 may include etching the receptacle wafer to form an optical path (e.g., similar to the first optical path window 548 and/or the second optical path window 547 as shown and described herein with respect to FIG. 5) for each of the one or more receptacles. For example, the optical paths may be similar to the optical path window as shown and described herein with respect to FIG. 4 and/or the optical paths and/or optical path windows as shown and described herein with respect to FIGS. 5 and 6.

As shown in block 706, the method 700 may include bonding the receptacle wafer to a photonic wafer including the one or more corresponding photonic ICs. In some embodiments, the photonic wafer may be similar to one or more of the photonic wafers as shown and described herein with respect to FIGS. 4-6. Additionally, or alternatively, the photonic ICs may be similar to one or more of the photonic ICs as shown and described herein with respect to FIGS. 1-6. In some embodiments, the receptacle wafer may be bonded to the photonic wafer using wafer-on-wafer bonding techniques.

In some embodiments, the method 700 may include thinning the receptacle wafer before and/or after bonding the receptacle wafer to the photonic wafer. Additionally, or alternatively, the method 700 may include, after bonding the receptacle wafer to the photonic wafer, debonding the carrier wafer from the receptacle wafer.

In some embodiments, the method 700 may include aligning each optical path of each of the one or more receptacles with a corresponding optical window of the one or more corresponding photonic ICs (e.g., before and/or while bonding the receptacle wafer to the photonic wafer). Additionally, or alternatively, the method 700 may include, after bonding the receptacle wafer to the photonic wafer, simultaneously dicing the receptacle wafer and the photonic wafer to form the one or more receptacles and the one or more corresponding photonic ICs. Further, dicing the receptacle wafer and the photonic wafer into individual dies may form singulated dies with receptacles (e.g., similar to the singular die 414 as shown and described herein with respect to FIG. 4).

In some embodiments, the method may include etching the receptacle wafer to form one or more mechanical alignment features for aligning one or more connectors. For example, the one or more mechanical alignment features may be similar to one or more of the mechanical alignment features shown and described herein with respect to FIGS. 4-6. In some embodiments, the one or more mechanical alignment features may extend into the receptacle wafer away from a surface for receiving the one or more connectors. Additionally, or alternatively, the one or more mechanical alignment features may protrude away from the receptacle wafer away from a surface for receiving the one or more connectors. In some embodiments, the carrier wafer may include one or more cavities corresponding to and configured to receive the one or more mechanical alignment features.

Method 700 may include additional embodiments, such as any single embodiment or any combination of embodiments described herein. Although FIG. 7 shows example blocks of method 700, in some embodiments, method 700 may include additional blocks, fewer blocks, different blocks, or differently arranged blocks than those depicted in FIG. 7. Additionally, or alternatively, two or more of the blocks of method 700 may be performed in parallel.

As will be appreciated by one of ordinary skill in the art in view of this disclosure, the present disclosure may include and/or be embodied as an apparatus (including, for example, a system, a machine, a device, and/or the like), as a method (including, for example, a manufacturing method, a robot-implemented process, and/or the like), or as any combination of the foregoing.

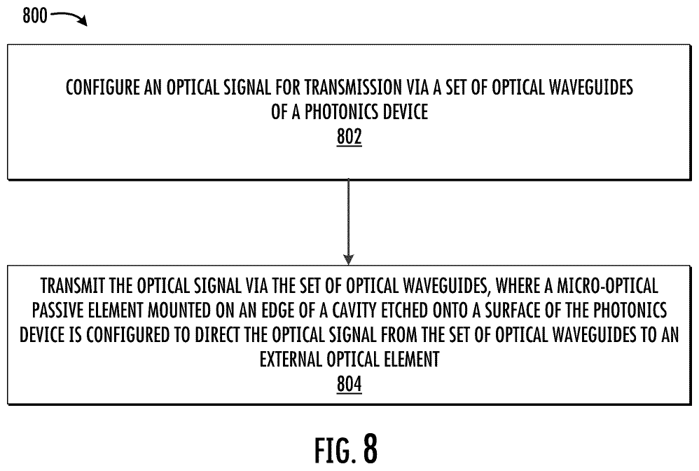

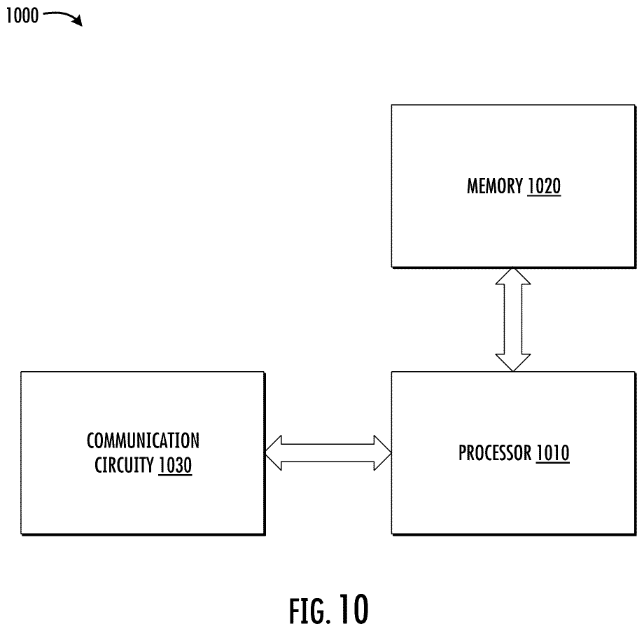

FIG. 8 is a flowchart illustrating an example method 800 for providing optical communications via a silicon photonics collimator in accordance with one or more embodiments of the present disclosure. It will be understood that each block of the flowcharts, and combinations of blocks in the flowcharts, may be implemented by various means. In some example embodiments, certain ones of the operations herein may be modified or further amplified as described below. Moreover, in some embodiments additional optional operations may also be included. It should be appreciated that each of the modifications, optional additions, or amplifications described herein may be included with the operations herein either alone or in combination with any others among the features described herein. The operations illustrated in FIG. 8 may, for example, be used to manufacture an example computing system 1000 (shown in FIG. 10).

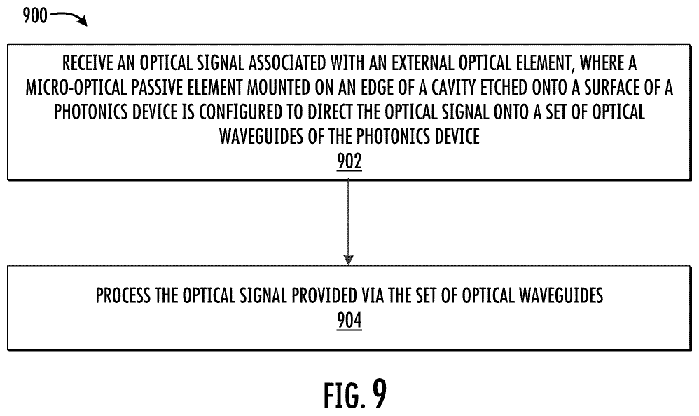

FIG. 9 is a flowchart illustrating an example method 900 for providing optical communications via a silicon photonics collimator in accordance with one or more embodiments of the present disclosure. It will be understood that each block of the flowcharts, and combinations of blocks in the flowcharts, may be implemented by various means. In some example embodiments, certain ones of the operations herein may be modified or further amplified as described below. Moreover, in some embodiments additional optional operations may also be included. It should be appreciated that each of the modifications, optional additions, or amplifications described herein may be included with the operations herein either alone or in combination with any others among the features described herein. The operations illustrated in FIG. 9 may, for example, be used to manufacture an example computing system 1000 (shown in FIG. 10).

FIG. 10 illustrates the computing system 1000 that may be embedded in an optical module (e.g., a silicon photonics transceiver module). In some cases, the computing system 1000 may be a firmware computing system communicatively coupled with, and configured to control, one or more circuit modules associated with an optical module (e.g., a silicon photonics transceiver module). For example, the computing system 1000 may be a firmware computing system and/or a controller computing system communicatively coupled with one or more circuit modules, such as an optical module (e.g., a silicon photonics transceiver module). The computing system 1000 may include or otherwise be in communication with a processor 1010, a memory circuitry 1020, and communication circuitry 1030. In some embodiments, the processor 1010 (which may include multiple or co-processors or any other processing circuitry associated with the processor) may be in communication with the memory circuitry 1020. The memory circuitry 1020 may comprise non-transitory memory circuitry and may include one or more volatile and/or non-volatile memories. In some examples, the memory circuitry 1020 may be an electronic storage device (e.g., a computer readable storage medium) configured to store data that may be retrievable by the processor 1010. In some examples, the data stored in the memory 1020 may include classical communication protocol data and/or quantum communication protocol data, or the like for enabling the apparatus to carry out various functions or methods in accordance with embodiments of the present disclosure, described herein.

In some examples, the processor 1010 may be embodied in a number of different ways. For example, the processor may be embodied as one or more of various hardware processing means such as a microprocessor, a coprocessor, a digital signal processor (DSP), a controller, or a processing element with or without an accompanying DSP. The processor 1010 may also be embodied in various other processing circuitry including integrated circuits such as, for example, an FPGA (field programmable gate array), a microcontroller unit (MCU), an ASIC (application specific integrated circuit), a hardware accelerator, or a special-purpose electronic chip. Furthermore, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining, and/or multithreading. In some embodiments, the processor 1010 is a microprocessor.

In an example embodiment, the processor 1010 may be configured to execute instructions, such as computer program code or instructions, stored in the memory circuitry 1020 or otherwise accessible to the processor 1010. Alternatively, or additionally, the processor 1010 may be configured to execute hard-coded functionality. As such, whether configured by hardware or software instructions, or by a combination thereof, the processor 1010 may represent a computing entity (e.g., physically embodied in circuitry) configured to perform operations according to an embodiment of the present disclosure described herein. For example, when the processor 1010 is embodied as an ASIC, FPGA, or similar, the processor may be configured as hardware for conducting the operations of an embodiment of the disclosure. Alternatively, when the processor 1010 is embodied to execute software or computer program instructions, the instructions may specifically configure the processor 1010 to perform the algorithms and/or operations described herein when the instructions are executed. However, in some cases, the processor 1010 may be a processor of a device (e.g., a mobile terminal, a fixed computing device, a semiconductor fabrication device, a robot device, etc.) specifically configured to employ an embodiment of the present disclosure by further configuration of the processor using instructions for performing the algorithms and/or operations described herein. The processor 1010 may further include a clock, an arithmetic logic unit (ALU) and logic gates configured to support operation of the processor 1010, among other things.

The computing system 1000 may also include the communication circuitry 1030. The communication circuitry may be any means embodied in either hardware or a combination of hardware and software that is configured to receive and/or transmit data from/to a network and/or any other device or module in communication with the computing system 1000. In this regard, the communication interface may include, for example, supporting hardware and/or software for enabling communications. As such, for example, the communication circuitry 1030 may include a communication modem and/or other hardware/software for supporting communication via cable, universal serial bus (USB), integrated circuit receiver, or other mechanisms.

A CPO package may integrate photonic high-speed optical interconnect components with functional switch application-specific integrated circuits (ASICs) or graphics processing units (GPUs) on a common substrate. By using CPO packages, computing systems may significantly reduce cost and power consumption over current systems. Current methods of manufacturing CPO packages involve optical elements that require active alignment in order to transmit the optical signal properly. In a traditional CPO package, an optical signal is transmitted via optical fibers to a connector that is either fixed (e.g., connected by adhesive) or detachable (e.g., connected by a clip) to a SiP die.

FIG. 11 illustrates a co-packaged system 1100, in accordance with an embodiment of the present disclosure. Co-packaging may refer to the close integration of different electrical and/or optoelectronic chips in the same package. The different chips that constitute the co-packaged system are assembled on a single substrate in what is typically called the MCM assembly 1112. The MCM assembly 1112 may include switching circuitry 1116 surrounded by peripheral or satellite chips 1120. Various example configurations of an MCM assembly 1112 will be described in further detail herein. In some embodiments, the switching circuitry 1116 and surrounding satellite chips 1120 are all mounted on a common substrate, although such a configuration is not required. The MCM assembly 1112 may be provided in a larger housing of a networking device 1126, positioned behind the front panel 1104. The switching circuitry 1116 may include one or more core digital Application Specific Integrated Circuits (ASICs), CPUs, GPUs, microprocessors, FPGAs, combinations thereof, and the like. The switching circuitry 1116 may include a number of input ports and/or output ports 1124. The Input/Output (I/O) ports 1124 may include electrical ports and/or optical ports. Additionally, the switching circuitry 1116 may include a combination of electrical blocks and optical blocks. The electrical blocks of the switching circuitry 1116 may include a number of electrical switches that are configured to route signals in an electrical domain. The optical blocks of the switching circuitry 1116 may include a number of optical components that are configured to generate, detect and route signals in an optical domain. The MCM assembly 1112, in some embodiments, may concern or include multiple satellite chips 1120 that are assembled on the same substrate as the switching circuitry 1116. In some embodiments, a configuration of the optical block(s) and a configuration of the electrical block(s) depends (e.g., is based on) on the number of optical ports in the I/O ports 1124.

Optical I/Os 1108, which may also be referred to as optical connectors, are placed at the front panel 1104. In some embodiments, connectivity between the MCM assembly 1112 and optical I/Os 1108 may be transferred to the front panel 1104 through optical fibers. This connection may be made directly with an optical I/O 1124 of the switching circuitry or may be made with one or more of the satellite chips 1136. The connection is often made with one or more of the satellite chips 1136 because the satellite chips 1136 may include the electro-optic converters and, possibly, the SERDES to natively support the connection. The satellite chips 1136 may include one or more of a DSP processor, driver, trans-impedance amplifier, laser, modulator, photodiode, serializer-deserializer, or the like.

Although many embodiments of the present disclosure have just been described above, the present disclosure may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present disclosure described and/or contemplated herein may be included in any of the other embodiments of the present disclosure described and/or contemplated herein, and/or vice versa.

While certain exemplary embodiments have been described and shown in the accompanying drawings, it is to be understood that such embodiments are merely illustrative of and not restrictive on the broad disclosure, and that this disclosure is not limited to the specific constructions and arrangements shown and described, since various other changes, combinations, omissions, modifications, and substitutions, in addition to those set forth in the above paragraphs, are possible. Those skilled in the art will appreciate that various adaptations, modifications, and combinations of the just described embodiments may be configured without departing from the scope and spirit of the disclosure. For example, devices, modules, components, and/or elements shown in the figures are not necessarily drawn to scale and may vary from that shown without departing from the scope and spirit of the disclosure. Therefore, it is to be understood that the disclosure may be practiced other than as specifically described herein.

What is claimed is:

1. A method of optically aligning a photonic wafer, comprising:
bonding a carrier wafer to a receptacle wafer comprising one or more receptacles for one or more corresponding photonic ICs, wherein each of the one or more receptacles is configured to receive a respective connector for its corresponding photonic IC;
etching the receptacle wafer to form an optical path for each of the one or more receptacles; and
bonding the receptacle wafer to the photonic wafer comprising the one or more corresponding photonic ICs.

2. The method of claim 1, comprising aligning each optical path of each of the one or more receptacles with a corresponding optical window of the one or more corresponding photonic ICs.

3. The method of claim 2, comprising, after bonding the receptacle wafer to the photonic wafer, debonding the carrier wafer from the receptacle wafer.

4. The method of claim 3, comprising, after bonding the receptacle wafer to the photonic wafer, simultaneously dicing the receptacle wafer and the photonic wafer to form the one or more receptacles and the one or more corresponding photonic ICs.

5. The method of claim 1, comprising thinning the receptacle wafer before bonding the receptacle wafer to the photonic wafer.

6. The method of claim 1, wherein etching the receptacle wafer to form the optical path for each of the one or more receptacles comprises etching the receptacle wafer to form the optical path for each of the one or more receptacles while the receptacle wafer is bonded to the carrier wafer.

7. The method of claim 1, comprising etching the receptacle wafer to form one or more mechanical alignment features for aligning one or more connectors.

8. The method of claim 7, wherein the one or more mechanical alignment features extend into the receptacle wafer away from a surface for receiving the one or more connectors.

9. The method of claim 7, wherein the one or more mechanical alignment features protrude away from the receptacle wafer away from a surface for receiving the one or more connectors.

10. The method of claim 9, wherein the carrier wafer comprises one or more cavities corresponding to and configured to receive the one or more mechanical alignment features.

11. An electronic module, comprising:
a photonic IC; and
a receptacle configured to receive a connector for the photonic IC, wherein the receptacle is wafer-bonded to the photonic IC.

12. The electronic module of claim 11, wherein the photonic IC comprises an optical window, wherein the receptacle comprises an optical path aligned with the optical window, and wherein the optical path is etched through the receptacle.

13. The electronic module of claim 12, wherein the optical path comprises adhesive bleeding stoppers configured to prevent adhesive securing the connector to the receptacle from entering the optical path.

14. The electronic module of claim 13, wherein the receptacle comprises one or more mechanical alignment features for aligning the connector with the photonic IC.

15. The electronic module of claim 14, wherein the one or more mechanical alignment features are formed via etching the receptacle.

16. The electronic module of claim 14, wherein the one or more mechanical alignment features extend into the receptacle away from a surface for receiving the connector.

17. The electronic module of claim 14, wherein the one or more mechanical alignment features protrude away from the receptacle away from a surface for receiving the connector.

18. The electronic module of claim 11, comprising:
the connector; and
a clip configured to secure the connector to the receptacle, wherein the receptacle and the connector are configured to optically align the connector with the photonic IC when the clip secures the connector to the receptacle.

19. The electronic module of claim 11, wherein the electronic module is deployed in a transceiver device.

20. The electronic module of claim 11, wherein the electronic module is deployed in a switch MCM.
